(19) United States
(12) Patent Application Publication
(10) Pub. No.: US 2026/0116730 A1
(43) Pub. Date: Apr. 30, 2026

(54) MOVEABLE SUPPORT FOR LIFT DEVICE

(71) Applicant: Oshkosh Corporation, Oshkosh, WI (US)

(72) Inventor: Devin Rosencrance, Oshkosh, WI (US)

(73) Assignee: Oshkosh Corporation, Oshkosh, WI (US)

(21) Appl. No.: 19/086,291

(22) Filed: Mar. 21, 2025

Related U.S. Application Data
(60) Provisional application No. 63/712,877, filed on Oct. 28, 2024.

(51) Int. Cl. B66F 17/00; B66F 11/04

(52) U.S. Cl. CPC B66F 17/006; B66F 11/042; B66F 11/046

(57) ABSTRACT

A lift vehicle includes a chassis, a platform, a lift apparatus, an extendable stabilizing member, an actuator, a load sensor, and a controller. The platform is configured to support an operator. The lift apparatus is configured to raise or lower the platform. The extendable stabilizing member is configured to selectively engage an external support surface to stabilize and support the platform. The actuator is configured to selectively move the extendable stabilizing member between a stowed position and a deployed position. The load sensor is configured to measure an amount of force applied to the extendable stabilizing member. The controller is configured to obtain the force being applied to the extendable stabilizing member and control a position of the extendable stabilizing member by the actuator based on the force being applied to the extendable stabilizing member.

### CROSS-REFERENCE TO RELATED PATENT APPLICATION

This application claims the benefit of and priority to U.S. Provisional Application No. 63/712,877, filed on Oct. 28, 2024, the entire disclosure of which is hereby incorporated by reference herein.

### BACKGROUND

Lift vehicles such as telehandlers, aerial work platforms, and the like, are often used to deliver a payload using a boom or arm. In many circumstances, the boom or arm of the lift vehicle must reach to great heights or extend to great lengths from the lift vehicle to deliver the payload to a destination. Extending the boom or arm to a great height or to great length from the lift vehicle may reduce stability of and/or exert high levels of stress on the lift vehicles in certain circumstances.

### SUMMARY

One implementation of the present disclosure is a lift vehicle, according to an exemplary embodiment. The lift vehicle includes a platform configured to support an operator and a lift apparatus configured to raise or lower the platform. The lift vehicle further includes an extendable stabilizing member coupled to the platform and configured to selectively engage an external support surface to stabilize and support the platform. The lift vehicle includes an actuator configured to selectively move the extendable stabilizing member between a stowed position and a deployed position, and a load sensor configured to measure an amount of force applied to the extendable stabilizing member. The lift vehicle further includes a controller configured to obtain the force being applied to the extendable stabilizing member from the load sensor and control the position of the extendable stabilizing member using the actuator based on the force being applied to the extendable stabilizing member.

Another implementation of the present disclosure is a platform for a lift device. The platform includes an extendable stabilizing member, and an actuator configured to extend or retract the extendable stabilizing member in a direction outwards from a chassis of the lift device. The platform further includes a load sensor configured to measure an amount of force applied to the extendable stabilizing member, a lock configured to selectively lock a position of the extendable stabilizing member, and a controller configured to: obtain the force being applied to the extendable stabilizing member from the load sensor, control the position of the extendable stabilizing member such that the force is less than or equal to a threshold force, and selectively engage the lock to lock the position of the extendable stabilizing member.

Another implementation of the present disclosure is a lift vehicle comprising a chassis, a lift apparatus configured to raise or lower an implement or platform, a stabilizing member configured to engage an external support to stabilize and support the implement or platform, a load sensor configured to measure an amount of force applied to the extendable stabilizing member, and a controller. The controller is configured to obtain the force being applied to the extendable stabilizing member from the load sensor, and control a position of the lift vehicle such that the force is less than or equal to a threshold force.

The invention is capable of other embodiments and of being carried out in various ways. Alternative exemplary embodiments relate to other features and combinations of features as may be recited herein.

### BRIEF DESCRIPTION OF THE FIGURES

FIG. 1 is a perspective view of a first lift vehicle, according to an exemplary embodiment.

FIG. 2 is a perspective view of a second lift vehicle, according to an exemplary embodiment.

FIG. 3A is a side view of a platform assembly of a lift vehicle, including a retracted extendable stabilizing member, according to an exemplary embodiment.

FIG. 3B is a side view of a platform assembly of a lift vehicle, including an extended extendable stabilizing member, according to an exemplary embodiment.

FIG. 4 is a block diagram of a controller for a lift vehicle, according to an exemplary embodiment.

FIG. 5 is a flow chart of a process for manually operating an extendable stabilizing member of a lift vehicle, according to an exemplary embodiment.

FIG. 6 is a flow chart of a process for automatically operating an extendable stabilizing member of a lift vehicle, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring generally to the FIGURES, a lift device (e.g., a boom, an articulated boom, a lift, a MEWP, a telehandler, etc.) includes a lift apparatus (e.g., a telescoping arm, an articulated arm, a boom arm, a boom, etc.) and a base supporting the lift apparatus. The lift apparatus is coupled to a platform (e.g., cabinet, container, base, structural member, etc.). The platform can include a plurality of couplings for power, high pressure air, hydraulics, and communication, etc., to connect the platform with the lift device. The platform assembly 192 includes one or more stabilizing bars which selectively extend from the platform and engage (e.g., contact, etc.) an external support to provide a stabilizing force supporting the platform when lifted by the device.

According to an exemplary embodiment, the lift device and stabilizing bar assembly of the present disclosure include a control system. The control system includes one or more controllers configured to operate the lift device and/or one or more moveable supports such as a stabilizing bar attachment according to different modes. In some embodiments, a single controller controls both the lift device and the stabilizing bar attachment. In other embodiments, there are dedicated controllers for each of the lift device and the stabilizing bar attachment. The modes include a manual mode and an autonomous mode. When operated in the manual mode, a user can control the lift device to position the stabilizing bar assembly in contact with an external support. That is, when operated in the manual mode, a user can extend the stabilizing bar (e.g., via providing one or more user inputs, etc.) to engage an external support proximate to the platform, thereby stabilizing the platform and lift assembly. When the stabilizing bar is operated in a manual mode, a user can control the stabilizing bar to operate to a desired load when the stabilizing bar is in contact with the external support.

According to an exemplary embodiment, when the stabilizing bar is operated in an autonomous mode, the stabilizing bar can autonomously place itself in contact with a supporting surface and maintain contact based one the input from one or more sensors. The stabilizing bar can monitor the force applied by the stabilizing bar to the lift device and adjust the position of the stabilizing bar based on the force applied by the stabilizing bar. When operating in autonomous mode, the stabilizing bar can detect proximity to a supporting surface to identify necessary distance of extension. When operating in autonomous model, the stabilizing bar can detect a supporting surface to use to stabilize the platform and lift device.

### Lift Device

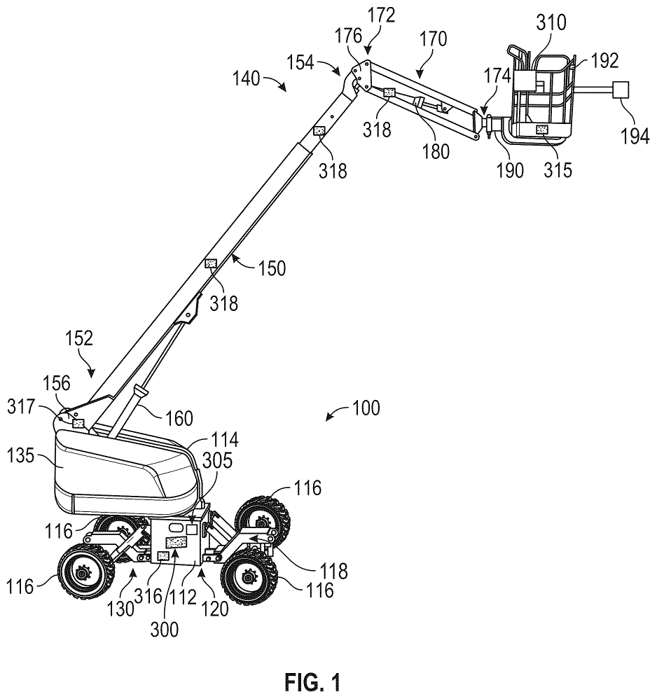

As shown in FIG. 1, a lift vehicle (e.g., an aerial work platform, a boom lift, etc.), shown as lift vehicle 100, includes a chassis, shown as chassis 118, a lift base 112 (e.g., a base, a main body, a vehicle, etc.), a platform assembly 192 (e.g., a platform, a work platform, a fork assembly, an apparatus, etc.), and a plurality of stabilizing bars, shown as stabilizing bars 194. The stabilizing bar 194 may be detachably coupled to the lift vehicle 100 such that the stabilizing bar 194 can be removed and replaced with a different implement assembly. In other embodiments, the lift vehicle 100 is another type of vehicle (e.g., a fire apparatus, a military vehicle, a fire apparatus, an airport rescue fire fighting (“ARFF”) truck, a boom truck, a refuse vehicle, a fork lift, etc.). According to the example shown in FIG. 1, the lift base 112 may support a rotatable structure, shown as turntable 114, and a boom assembly, shown as boom 140. According to an exemplary embodiment, the turntable 114 is rotatable relative to the lift base 112. In one embodiment, the turntable 114 includes a counterweight positioned at a rear of the turntable 114. In other embodiments, the counterweight is otherwise positioned and/or at least a portion of the weight thereof is otherwise distributed throughout the lift vehicle 100 (e.g., on the lift base 112, on a portion of the boom 140, etc.).

According to an exemplary embodiment, the lift vehicle 100 is configured to move between an extended work configuration (i.e., an operating position) and a more compact position (i.e., a stowed position). In the operating (e.g., deployed, etc.) position, the platform assembly 192 and stabilizing bar 194 are extended upward, outward, forward, and distal from the chassis 118 and forward from the lift vehicle 100, generally. In the stowed position, the stabilizing bar 194 are retracted inward, nearer, and proximal the chassis 118 (e.g., relative to the deployed position, etc.). In some embodiments, the lift vehicle 100 can also be positioned in a plurality of other positions.

As shown in FIG. 1, a first end, shown as front end 120, and an opposing second end, shown as rear end 130, of the lift base 112 is supported by a plurality of tractive elements, shown as tractive elements 116. According to the exemplary embodiment shown in FIG. 1, the tractive elements 116 include wheels. In other embodiments, the tractive elements 116 include track elements or some other tractive element. The lift vehicle 100 may include a plurality of drive actuators that may be positioned to facilitate the independent and selective driving one of the tractive elements 116 to move the lift vehicle 100. In some embodiments, the lift vehicle 100 may only include drive actuators positioned to drive the front tractive elements 116. In another embodiment, the lift vehicle 100 may include drive actuators positioned to drive the front tractive elements 116 and the rear tractive elements 116. In yet other embodiments, the lift vehicle 100 may include drive actuators positioned to drive the rear tractive elements 116. Furthermore, in some embodiments, the lift vehicle 100 may include a plurality of brakes (e.g., one for each tractive element 116, etc.) positioned to independently and selectively restrict rotation of each of the tractive elements 116.

Each of the tractive elements 116 may be powered or unpowered. In some embodiments, the lift vehicle 100 includes a powertrain system including a prime mover 135 (e.g., an engine, an electric motor, etc.). The prime mover 135 may receive fuel (e.g., gasoline, diesel, natural gas, etc.) from a fuel tank and combust the fuel to generate mechanical energy. According to an exemplary embodiment, the prime mover 135 is a compression-ignition internal combustion engine that utilizes diesel fuel. In alternative embodiments, the prime mover 135 is another type of device (e.g., spark-ignition engine, fuel cell, etc.) that is otherwise powered (e.g., with gasoline, compressed natural gas, hydrogen, etc.). Additionally or alternatively, the prime mover 135 include an electric motor that receives electrical energy from one or more energy storage devices (e.g., batteries, capacitors, etc.) or an offboard source of electrical energy (e.g., a power grid, a generator, etc.). In some embodiments, one or more pumps (e.g., a charge pump, an implement pump, and a drive pump) receive the mechanical energy from the prime mover 135 and provide pressurized hydraulic fluid to power the tractive elements 116 and the other hydraulic components of the lift vehicle 100 (e.g., the lift cylinder 160). In some embodiments, the aforementioned charge pump, implement pump, and drive pump provide pressurized hydraulic fluid to drivers or actuators (e.g., hydraulic motors), that are each coupled to one or more of the tractive elements 116 (e.g., in a hydrostatic transmission arrangement). The drive motors each provide mechanical energy to one or more of the tractive elements 116 to propel the lift vehicle 100. In other embodiments, one drive motor drives all of the tractive elements 116. In other embodiments, the prime mover 135 provides mechanical energy to the tractive elements 116 through another type of transmission.

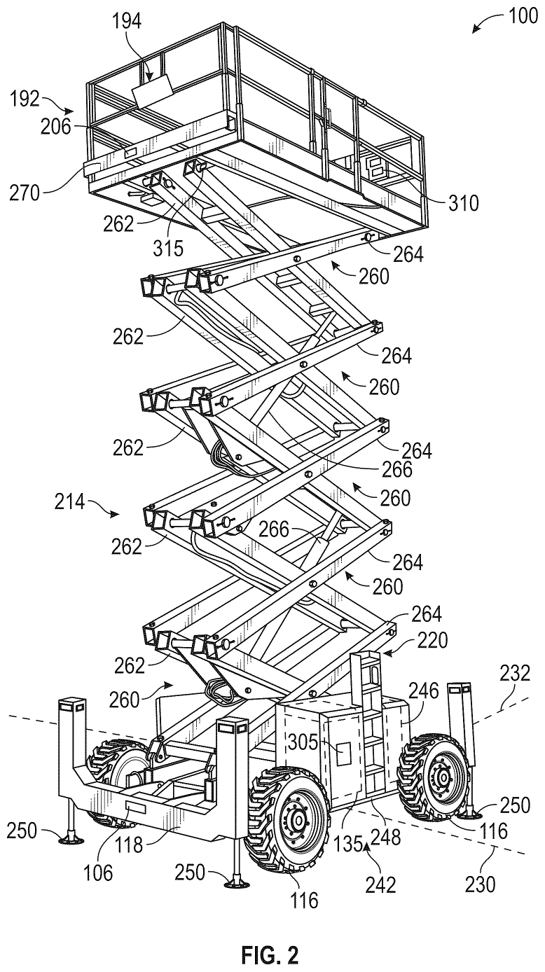

As shown in FIG. 1, the boom 140 includes a first boom section, shown as lower boom 150, and a second boom section, shown as upper boom 170. In other embodiments, the boom 140 includes a different number and/or arrangement of boom sections (e.g., one, three, etc.). According to an exemplary embodiment, the boom 140 is an articulating boom assembly. In one embodiment, the upper boom 170 is shorter in length than the lower boom 150. In other embodiments, the upper boom 170 is longer in length than the lower boom 150. According to another exemplary embodiment, the boom 140 may be telescopic and/or articulating boom assembly, such as the boom assembly 240 discussed with reference to FIG. 2 below. By way of example, the lower boom 150 and/or the upper boom 170 may include a plurality of telescoping boom sections that are configured to extend and retract along a longitudinal centerline thereof to selectively increase and decrease a length of the boom 140.

As shown in FIG. 1, the lower boom 150 has a first end (e.g., a lower end, etc.), shown as base end 152, and an opposing second end, shown as intermediate end 154. The base end 152 of the lower boom 150 is pivotally coupled (e.g., pinned, etc.) to the turntable 114 at a joint, shown as lower boom pivot 156. As shown in FIG. 1, the lift vehicle 100 includes a hydraulic system comprising a plurality of hydraulic actuators 160, 180, etc. The boom 140 includes a first actuator (e.g., pneumatic cylinder, electric actuator, hydraulic cylinder, etc.), shown as lower lift cylinder 160. The lower lift cylinder 160 has a first end coupled to the turntable 114 and an opposing second end coupled to the lower boom 150. According to an exemplary embodiment, the lower lift cylinder 160 is positioned to raise and lower the lower boom 150 relative to the turntable 114 about the lower boom pivot 156 (e.g., to rotate the boom 140 about the boom pivot 156).

As shown in FIG. 1, the upper boom 170 has a first end, shown as intermediate end 172, and an opposing second end, shown as implement end 174. The intermediate end 172 of the upper boom 170 is pivotally coupled (e.g., pinned, etc.) to the intermediate end 154 of the lower boom 150 at a joint, shown as upper boom pivot 176. As shown in FIG. 1, the boom 140 includes an implement, shown as platform assembly 192, coupled to the implement end 174 of the upper boom 170 with an extension arm, shown as jib arm 190. In some embodiments, the jib arm 190 is configured to facilitate pivoting the platform assembly 192 about a lateral axis (e.g., pivot the platform assembly 192 up and down, etc.). In some embodiments, the jib arm 190 is configured to facilitate pivoting the platform assembly 192 about a vertical axis (e.g., pivot the platform assembly 192 left and right, etc.). In some embodiments, the jib arm 190 is configured to facilitate extending and retracting the platform assembly 192 relative to the implement end 174 of the upper boom 170. As shown in FIG. 1, the boom 140 includes a second actuator (e.g., pneumatic cylinder, electric actuator, hydraulic cylinder, etc.), shown as upper lift cylinder 180. According to an exemplary embodiment, the upper lift cylinder 180 is positioned to actuate (e.g., lift, rotate, elevate, etc.) the upper boom 170 and the platform assembly 192 relative to the lower boom 150 about the upper boom pivot 176.

According to an exemplary embodiment, the platform assembly 192 is a structure that is particularly configured to support one or more workers. In some embodiments, the platform assembly 192 includes an accessory or tool configured for use by a worker. Such tools may include pneumatic tools (e.g., impact wrench, airbrush, nail gun, ratchet, etc.), plasma cutters, welders, spotlights, etc. In some embodiments, the platform assembly 192 includes a control panel to control operation of the lift vehicle 100 (e.g., the turntable 114, the boom 140, etc.) from the platform assembly 192. In other embodiments, the platform assembly 192 includes or is replaced with an accessory and/or tool (e.g., forklift forks, etc.).

Though not described in detail herein, it is understood that the lift vehicle 100 as shown in FIG. 1 could include a leveling system configured to adjust the base 112 in order to ensure that the base 112 and lift vehicle 100 generally remains level relative to a horizontal reference plane. Such a leveling system is described in U.S. Pat. No. 10,858,231, which is incorporated by reference herein in its entirety.

As shown in FIG. 1, the lift vehicle 100 may further include a control system 300 configured to dynamically determine an operating envelope for the lift vehicle 100, monitor one or more sensors associated with the lift vehicle 100, and control the lift vehicle 100, among other operations or processes. The “operating envelope” refers to a reach envelope defining an area that the lift vehicle 100 can reach safely. The control system 300 may determine (e.g., define, establish, create, generate) an operating envelope for the lift vehicle 100 based on one or more parameters, including sensor data, user inputs, etc. For example, as shown in FIG. 1, the control system 300 may include one or more controllers 305, one or more load sensors 315, one or more vehicle base inclination sensors 316, one or more rotation sensors 317, and/or one or more boom length sensors 318. According to an exemplary embodiment, the control system 300 may facilitate the determination of an operating envelope for the lift vehicle 100 using data monitored or recorded by the load sensor 315, the vehicle base inclination sensor 316, the rotation sensor 317, the boom length sensor 318, and/or data provided by other sources, as is discussed further below. For example, the control system 300 may determine an operating envelope based on data from the load sensor 315 and the boom length sensor 318 such that the boom 140 can operate within the operating envelope but cannot operate outside of the operating envelope. The control system 300 can determine an operating envelope based on data from one or more sensors to prevent or reduce the incidence of an unstable condition of the lift vehicle 100. The “unstable condition” refers to the lift vehicle 100 having the potential to move (e.g., forward or backward, rotating, etc.) when undesired (e.g., not requested by the operator and/or the control system 300). For example, in some instances, the control system 300 may determine, based on sensor data received from the various sensors, that lifting a particular load on the platform assembly 192 past a certain height or distance from the lift vehicle 100 will create sufficient stress on the boom 140 to potentially tip the lift vehicle 100. As such, the control system 300 may determine that this height or distances is an outer edge of the operating envelope. The control system 300 can determine an operating envelope based on data from one or more sensors to substantially maintain the stability of the lift vehicle 100. The “stability” of the lift vehicle 100 refers to the ability of the lift vehicle 100 to operate without substantially moving (e.g., forward or backwards, rotating, etc.) when undesired (e.g., not requested by the operator and/or the control system 300, etc.).

In one embodiment, the operating envelope determined by the control system 300 may be defined as the space within which boom 140 of the lift vehicle 100 may operate, including, in some embodiments, extension in both the vertical and horizontal directions. In some embodiments, the operating envelope may be a two-dimensional planar region for lift vehicle 100 having no rotatable turntable 114. In other embodiments, specifically embodiments where the lift vehicle 100 does have a rotatable turntable 114, the operating envelope may be the swept volume defined by the reach of the boom 140 (e.g., the reach envelope, etc.) over a plurality of lift angles and the rotation of the turntable 114 about the base 112. In this way, the operating envelope may be expressed as a three-dimensional volume. For example, when data indicates that the lift vehicle 100 is unstable (e.g., unsupported, etc.), the control system 300 may determine that the operating envelope is smaller than when the lift vehicle 100 is supported, and vice-versa.

For example, the control system 300 may determine that the lift vehicle 100 is currently unsupported and that the stabilizing bar 194 are in the stowed position, thereby determining that the operating envelope is smaller than if the lift vehicle 100 is supported. In these instances, the control system 300 may require a user input to indicate that the stabilizing bar 194 will be deployed against a support structure and that the reach envelope should be larger. In this manner, responsive to receiving the user input indicating that the stabilizing bar 194 will be deployed and that the lift vehicle 100 will be supported, the control system 300 may increase the reach envelope within which the lift vehicle 100 is allowed to operate.

In various embodiments, the control system 300 may control the lift vehicle 100 in order to allow the lift vehicle 100 to operate within (and up to) one or more boundaries defined by the operating envelope. The control system 300 may positively control the lift vehicle 100 (e.g., allowing certain functions or operator commands to proceed) or may negatively control the lift vehicle 100 (e.g., by prohibiting certain functions or operator commands) based on an operating envelope. For example, the control system 300 may allow the boom 140 of the lift vehicle 100 to extend up to the boundary of the operating envelope. In another example, the control system 300 may allow the lift vehicle 100 to move (e.g., by operating the tractive elements 116 to drive the lift vehicle 100), provided the boom 140 is within the operating envelope.

According to the exemplary embodiment shown in FIG. 2, a lift vehicle (e.g., a scissor lift, an aerial work platform, a boom lift, a telehandler, etc.), shown as lift vehicle 100, includes a chassis, shown as chassis 118. A lift device (e.g., a scissor assembly, a boom assembly, etc.), shown as lift assembly 214, couples chassis 118 to a platform, shown as platform assembly 192. Chassis 118 supports lift assembly 214 and platform assembly 192, both of which are disposed directly above chassis 118. In use, lift assembly 214 extends and retracts to raise and lower platform assembly 192 relative to chassis 118 between a lowered position and a raised position. Lift vehicle 100 includes an access assembly, shown as an access assembly 220, that is coupled to chassis 118 and configured to facilitate access to platform assembly 192 from the ground by an operator when platform assembly 192 is in the lowered position.

Referring again to FIG. 2, chassis 118 defines a horizontal plane having a lateral axis 230 and a longitudinal axis 232. In some embodiments, chassis 118 is rectangular, defining lateral sides extending parallel to lateral axis 230 and longitudinal sides extending parallel to longitudinal axis 232. In some embodiments, chassis 118 is longer in a longitudinal direction than in a lateral direction. In some embodiments, lift vehicle 100 is configured to be stationary or semi-permanent (e.g., a system that is installed in one location at a work site for the duration of a construction project). In such embodiments, chassis 118 may be configured to rest directly on the ground and/or lift vehicle 100 may not provide powered movement across the ground. In other embodiments, lift vehicle 100 is configured to be moved frequently (e.g., to work on different tasks, to continue the same task in multiple locations, to travel across a job site, etc.). Such embodiments may include systems that provide powered movement across the ground.

Referring to FIG. 2, lift vehicle 100 is supported by a plurality of tractive elements 116, each including a tractive element (e.g., a tire, a track, etc.), that are rotatably coupled to chassis 118. tractive elements 116 may be powered or unpowered. As shown in FIG. 2, tractive elements 116 are configured to provide powered motion in the direction of longitudinal axis 232. One or more of tractive elements 116 may be turnable to steer lift vehicle 100. In some embodiments, lift vehicle 100 includes a powertrain system 242. In some embodiments, powertrain system 242 includes a prime mover 135 (e.g., an engine). A transmission may receive the mechanical energy and provide an output to one or more of tractive elements 116. In some embodiments, powertrain system 242 includes a pump 246 configured to receive mechanical energy from prime mover 135 and output a pressurized flow of hydraulic fluid. Pump 246 may supply mechanical energy (e.g., through a pressurized flow of hydraulic fluid) to individual motive drivers (e.g., hydraulic motors) configured to facilitate independently driving each of tractive elements 116. In other embodiments, powertrain system 242 includes an energy storage device (e.g., a battery, capacitors, ultra-capacitors, etc.) and/or is electrically coupled to an outside source of electrical energy (e.g., a standard power outlet). In some such embodiments, one or more of tractive elements 116 include an individual motive driver (e.g., a motor that is electrically coupled to the energy storage device, etc.) configured to facilitate independently driving each of tractive elements 116. The outside source of electrical energy may charge the energy storage device or power the motive drivers directly. Powertrain system 242 may additionally or alternatively provide mechanical energy (e.g., using the pump 246, by supplying electrical energy, etc.) to one or more actuators of lift vehicle 100 (e.g., leveling actuators 250, lift actuators 266, etc.). One or more components of powertrain system 242 may be housed in an enclosure, shown as housing 248. Housing 248 is coupled to chassis 118 and extends from a side of lift vehicle 100 (e.g., a left or right side). Housing 248 may include one or more doors to facilitate access to components of powertrain system 242.

In some embodiments, chassis 118 is coupled to one or more actuators, shown in FIG. 2 as leveling actuators 250. Lift vehicle 100 includes four leveling actuators 250, one in each corner of chassis 118. Leveling actuators 250 extend and retract vertically between a stored position and a deployed position. In the stored position, leveling actuators 250 are raised and do not contact the ground. In the deployed position, leveling actuators 250 contact the ground, lifting chassis 118. The length of each of leveling actuators 250 in their respective deployed positions may be varied to adjust the pitch (i.e., rotational position about lateral axis 230) and the roll (i.e., rotational position about longitudinal axis 232) of chassis 118. Accordingly, the lengths of leveling actuators 250 in their respective deployed positions may be adjusted such that chassis 118 is leveled with respect to the direction of gravity, even on uneven or sloped terrains. Leveling actuators 250 may additionally lift the tractive elements of tractive elements 116 off the ground, preventing inadvertent driving of lift vehicle 100.

Referring to FIG. 2, lift assembly 214 includes a number of subassemblies, shown as scissor layers 260, each including a first member, shown as inner member 262, and a second member, shown as outer member 264. In each scissor layer 260, outer member 264 receives inner member 262. Inner member 262 is pivotally coupled to outer member 264 near the centers of both inner member 262 and outer member 264. Accordingly, inner member 262 pivots relative to the outer member 264 about a lateral axis. Scissor layers 260 are stacked atop one another to form lift assembly 214. Each inner member 262 and each outer member 264 has a top end and a bottom end. The bottom end of each inner member 262 is pivotally coupled to the top end of the outer member 264 immediately below it, and the bottom end of each outer member 264 is pivotally coupled to the top end of inner member 262 immediately below it. Accordingly, each of scissor layers 260 are coupled to one another such that movement of one scissor layer 260 causes a similar movement in all of the other scissor layers 260. The bottom ends of inner member 262 and outer member 264 belonging to the lowermost of scissor layers 260 are coupled to chassis 118. The top ends of inner member 262 and outer member 264 belonging to the uppermost of scissor layers 260 are coupled to platform assembly 192. Inner members 262 and/or outer members 264 are slidably coupled to chassis 118 and platform assembly 192 to facilitate the movement of lift assembly 214. Scissor layers 260 may be added to or removed from lift assembly 214 to increase or decrease, respectively, the maximum height that platform assembly 192 is configured to reach.

One or more actuators (e.g., hydraulic cylinders, pneumatic cylinders, motor-driven leadscrews, etc.), shown as lift actuators 266, are configured to extend and retract lift assembly 214. As shown in FIG. 2, lift assembly 214 includes a pair of lift actuators 266. Lift actuators 266 are pivotally coupled to an inner member 262 at one end and pivotally coupled to another inner member 262 at the opposite end. These inner members 262 belong to a first scissor layer 260 and a second scissor layer 260 that are separated by a third scissor layer 260. In other embodiments, lift assembly 214 includes more or fewer lift actuators 266 and/or lift actuators 266 are otherwise arranged. Lift actuators 266 are configured to actuate lift assembly 214 to selectively reposition platform assembly 192 between the lowered position, where platform assembly 192 is proximate chassis 118, and the raised position, where platform assembly 192 is at an elevated height. In some embodiments, extension of lift actuators 266 moves platform assembly 192 vertically upward (extending lift assembly 214), and retraction of the linear actuators moves platform assembly 192 vertically downward (retracting lift assembly 214). In other embodiments, extension of lift actuators 266 retracts lift assembly 214, and retraction of lift actuators 266 extends lift assembly 214. In some embodiments, outer members 264 are approximately parallel and/or contacting one another when with lift assembly 214 in a stored position. Lift vehicle 100 may include various components to drive lift actuators 266 (e.g., pumps, valves, compressors, motors, batteries, voltage regulators, etc.).

Referring again to FIG. 2, platform assembly 192 includes a support surface, shown as deck 270, defining a top surface configured to support operators and/or equipment and a bottom surface opposite the top surface. The bottom surface and/or the top surface extend in a substantially horizontal plane. A thickness of deck 270 is defined between the top surface and the bottom surface. The bottom surface is coupled to a top end of lift assembly 214. In some embodiments, deck 270 is rectangular. In some embodiments, deck 270 has a footprint that is substantially similar to that of chassis 118.

Lift vehicle 100 includes a controller 305, according to some embodiments. Controller 305 is configured to receive sensor information from various sensors of lift vehicle 100, feedback from any pumps, engines, actuators, etc., of lift vehicle 100, and operate any controllable elements (e.g., operate tractive assemblies 116 to drive lift vehicle 100, operate lift actuators 266 to raise or lower platform assembly 192, etc.) based on any of the sensory inputs, user inputs, etc. Controller 305 can operate any controllable elements of lift vehicle 100 by generating and providing control signals to the controllable elements. Controller 305 can be disposed at chassis 118 (as shown in FIG. 2), or can be positioned anywhere on lift vehicle 100.

Orientation sensor 206 can provide controller 305 with real-time orientation information of lift vehicle 100. Advantageously, this facilitates providing the operator with an indication regarding whether or not the maximum allowable height of platform assembly 192 is sufficient to reach the desired work area. Controller 305 can determine the maximum allowable height of platform assembly 192 and restrict lift assembly 214 from raising platform assembly 192 above the maximum allowable height. In some embodiments, controller 305 determines the maximum allowable height of platform assembly 192 in real time, and displays the maximum allowable height to the operator in real time.

Lift vehicle 100 may include a load sensor, a weight sensor, a strain gauge, etc., shown as load sensor 315. Load sensor 315 is configured to measure a current weight of platform assembly 192. In some embodiments, a load-free weight of platform assembly 192 is known (e.g., a weight of platform assembly 192 without any operators, workers, objects, etc., on platform assembly 192) and the amount of load (e.g., weight due to workers, equipment, tools, etc., being present on platform assembly 192) applied to platform assembly 192 can be determined by controller 305. In some embodiments, controller 305 can receive the measured load/weight from load sensor 315 and determine the maximum allowable height of platform assembly 192 based on the measured load/weight of platform assembly 192. In some embodiments, controller 305 uses the measured load/weight received from load sensor 315 to determine if the current load applied to platform assembly 192 exceeds a maximum load rating (e.g., a maximum allowable load). In some embodiments, controller 305 receives the measured load/weight received from load sensor 315 and displays the current load applied at platform assembly 192 to the operator.

Load sensor 315 can be configured to measure weight of platform assembly 192 or can be configured to measure weight of both platform assembly 192 and lift assembly 214. In some embodiments, load sensor 315 is or includes a collection of load/weight sensors. For example, a first load sensor 315 can be disposed at the connection/coupling between lift assembly 214 and platform assembly 192, while a second load sensor 315 can be disposed at the connection/coupling between lift assembly 214 and chassis 118. Load sensor 315 can be positioned anywhere else on lift vehicle 100 such that load sensor 315 can measure weight of operators, equipment, parts, tools, etc., or any other objects or persons on platform assembly 192.

### Stabilizing Bar

As shown in FIG. 1-3B, platform assembly 192 includes one or more extendable stabilizing members, shown as extendable stabilizing bar 194. The stabilizing bar 194 is positioned along a front of the plurality of faces of platform assembly 192, facing opposite from the platform assembly 192. In some embodiments, the stabilizing bar may be coupled to another side of the platform assembly 192, such as the rear or side. The stabilizing bar 194 is coupled at vertical midpoint of the platform assembly 192. In some embodiments, the stabilizing bar 194 may be positioned at a different height of the platform assembly 192. In some embodiments, the stabilizing bar 194 may be attached to the platform assembly 192 such that the height of the stabilizing bar 194 relative to the platform assembly 192 is adjustable (e.g., slidably coupled, a platform assembly with multiple mounting sites, etc.). For example, the stabilizing bar 194 may be coupled to a rail, slot, channel, support, and one or more actuators or translating assemblies to adjust a height of the stabilizing bar 194 on the platform 192. In some embodiments, the stabilizing bar 194 may be attached to an upper portion of a boom (e.g., the boom 150) or an upper portion of a lift assembly (e.g., the lift assembly 214).

The stabilizing bar 194 is selectively extendable from platform assembly 192 in a direction perpendicular to a front of the platform assembly 192 to engage (e.g., contact) an external support. In some embodiments, the stabilizing bar 194 can extend out from the bottom of the platform assembly 192 at a downward angle. In some embodiments, the stabilizing bar 194 could extend out from the top of the platform assembly 192 at an upward angle. The stabilizing bar 194 is extended or retracted by one or more linear actuators (e.g., electric, pneumatic, hydraulic, etc.), shown as stabilizing bar actuators 200. In some embodiments, a single stabilizing bar actuator 200 can be used. In some embodiments, the stabilizing bar 194 is manually extended and retracted (e.g., lever, gear system, etc.). In some embodiments, the stabilizing bar 194 further includes a mechanical lock to lock the stabilizing bar 194 in position.

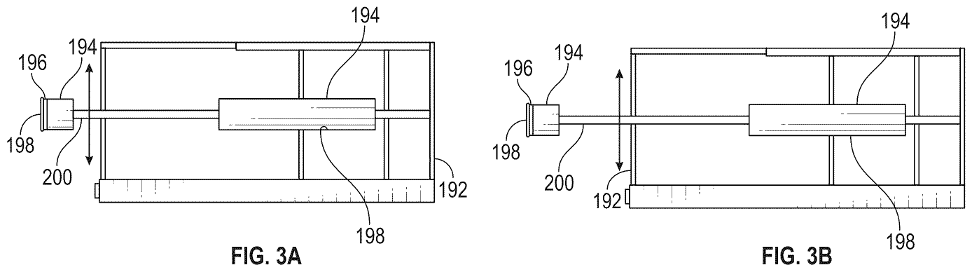

According to an exemplary embodiment, the stabilizing bar 194 is movable between a first position (e.g., that shown in FIG. 3A) defined by a first distance between a stabilizing bar front 196 and the lift vehicle 100, and a second position (e.g., that shown in FIG. 3B) defined by a second distance between the stabilizing bar front 196 and the lift device 100, the second distance larger than the first. The stabilizing bar 194 can also move to any position between the first and second positions. In some embodiments, the first and second distances can also be measured between the stabilizing bar front 196 and the platform assembly 192.

During operation, the stabilizing bar 194 can be actuated from the first position to the second position to engage (e.g., contact) an external support. In some embodiments, the extension of the stabilizing bar 194 is a manually operated process, wherein the user operates one or more of a plurality of user interface devices, shown as user interface devices 310, to drive the stabilizing bar 194 to a user-input position or force threshold (e.g., to apply 50 lbs of force, 100 lbs of force, etc.) via actuation of the stabilizing bar 194 by the stabilizing bar actuator 200. In some embodiments, the user interface devices 310 may include a graphical user interface, any number of buttons, levers, knobs, switches, speakers, lights, etc., or any other user interface devices configured to interact with the operator of lift vehicle 100. The user interface devices 310 can be positioned anywhere on the lift vehicle 100, the extendable stabilizing bar 194, or be portable for the operator to carry. In some embodiments, the extension of the stabilizing bar 194 is an automatic process, wherein the controller operates the stabilizing bar actuator 200 to extend or retract the stabilizing bar 194 based on a plurality of sensed values regarding the state of the lift vehicle 100, the platform assembly 192, the stabilizing bar 194, and any other relevant parameters or the lift vehicle 100, such as the position of the stabilizing bar, the distance from a support surface, a force applied by the stabilizing bar, etc.

In some embodiments, the stabilizing bar 194 may be stationary (e.g., fixed in the second position shown in FIG. 3B) instead of being selectively extendable via an actuator. For example, in some instances, instead of or in addition to the stabilizing bar 194 being operable to move between the first and second position, the operator may control the lift vehicle 100 to move (e.g., via a command to the tractive elements 116) to move the stabilizing bar 194 into engagement with the support surface to stabilize the lift vehicle 100. In these instances, the controller 305 may monitor the force being applied to the stabilizing bar 194 by the support surface and control the lift vehicle 100 to move toward or away from the support surface to ensure that the applied force is at an appropriate level.

In some embodiments, the user interface devices 310 may be on the extendable stabilizing bar 194 and positioned such that the operator can access these devices. For example, the stabilizing bar 194 may include an LED bar configured to indicate the force applied by the bar. The LED bar may be configured such that it displays green for an acceptable level of force and red for too much or too little force. In another example, the LED bar may be configured to indicate the position of the stabilizing bar 194 such that it displays green when the stabilizing bar 194 is in compliance with the desired position and displays red when the stabilizing bar 194 is not in a compliant position.

In some embodiments, the user interface devices 310 may include a speaker configured to provide the operator with an audible indication regarding at least one of the position or the force applied by the extendable stabilizing bar 194. For example, the speaker may be configured such that it provides an operator with audible indications that may be at various frequencies, tones, and volumes depending on state of the lift vehicle 100, the platform assembly 192, the extendable stabilizing bar 194, or any other relevant parameter monitored by the controller 305.

The contact between the stabilizing bar 194 and the external support, in addition to the support provided by the lift apparatus, stabilizes the platform assembly 192 by providing an additional point of contact and force in addition to that provided by the lift vehicle 100. The additional point of contact can reduce the unsupported length, and the moment around both the chassis and the platform. In this manner, the operating envelope of the lift vehicle 100 may be larger when the stabilizing bar 194 is deployed compared to when the stabilizing bar 194 is stowed. That is, the control system 300 may allow the lift vehicle 100 to extend farther when the stabilizing bar 194 is deployed or when the user indicates that the stabilizing bar 194 will be deployed than when the stabilizing bar 194 is stowed.

In some embodiments, the stabilizing bar 194 includes a bumper shown as bumper 198 positioned at the stabilizing bar front 196. In some embodiment, bumper 198 is configured to cushion an impact between the stabilizing bar 194 and the external support. In some embodiments, the bumper 198 and/or the stabilizing bar 194 is made of a flexible or elastic material, such as, for example, plastic, rubber, silicone, or polyurethane. In this manner, the bumper 198 and/or the stabilizing bar 194 do not damage the external support surface when engaged with the external support surface. In some embodiments, the bumper 198 is made of a high friction material such as a rubber or a metal. In some embodiments, the surface of the bumper 198 is textured to increase the sliding friction between the bumper 198 and the external support. In some embodiments, the bumper 198 can be substantially hollow. The bumper 198 can be a single, unitary piece, or be made of multiple individual pieces. In some embodiments, the bumper 198 only covers a portion of the stabilizing bar front 196.

In some embodiments, the stabilizing bar 194 can be applied to a boom lift such that the stabilizing bar 194 is coupled to the platform assembly 192. The stabilizing bar 194 can be operated such that the stabilizing bar 194 selectively extends from the platform assembly 192 to contact an external support via the stabilizing bar bumper 198. Upon contact, the platform assembly 192, and the lift vehicle 100 are supported by the external support.

In some embodiments, the stabilizing bar can be applied to a scissor lift such that the stabilizing bar is coupled to the platform assembly 192. The stabilizing bar 194 can be operated such that the stabilizing bar 194 selectively extends from the platform assembly 192 to contact an external support via the stabilizing bar bumper 198. Upon contact, the platform assembly 192, the lift assembly 214, and the lift vehicle 100 are now supported by the external support. In some embodiments, a scissor lift such as lift vehicle 100 shown in FIG. 2 has a strong axis along a length of the scissor lift 100 (the longitudinal axis 232) and a weak axis along the width of the scissor lift (the lateral axis 230). In some embodiments, the stabilizer bar 194 may be positioned to support the weak axis of the scissor lift, making the lateral axis strengthened and more stable.

Now referring to FIGS. 3A and 3B, according to an exemplary embodiment, the platform assembly 192 includes at least one extendable stabilizing bar 194 which includes a stabilizing bar front 196, a stabilizing bar bumper 198, and at least one stabilizing bar actuator 200. As shown in the figures, the extendable stabilizing bar 194 expands and retracts as a result of the extension of the stabilizing bar actuator 200. As shown in FIGS. 3A and 3B, in some embodiments, the platform assembly 192 includes a pair of extendable stabilizing bars 194 (e.g., one that is extendable leftward, with respect to FIGS. 3A and 3B, and one that is extendable forward or out of the page with respect to FIGS. 3A and 3B) for stabilizing the platform assembly 192 in multiple directions.

In some embodiments, the extendable stabilizing bar 194 may include multiple stabilizing bar bumper 198. In some embodiments, the stabilizing bar bumper 198 may be mounted on opposing sides of extendable stabilizing bar 194 such that each of the opposing sides are covered by the stabilizing bar bumper 198. In some other embodiments, the extendable stabilizing bar 194 may include a stabilizing bar bumper 198 on all sides. In yet another embodiment, there may me multiple extendable stabilizing bars 194 vertically aligned such that when in contact with the external support surface, the contact surface area is larger compared to the surface area when only one stabilizing bar bumper 198 is in contact with the external support surface. This larger surface area can promote friction between each surface and distribute the force being applied to each surface across a larger area, reducing pressure exerted on each point. In yet another embodiment, the extendible stabilizing bar member 194 may include at least one stabilizing bar bumper 198 at each corner. In some embodiments, there may be extendable stabilizing bars 194 at one or more corners of the platform assembly 192. In some embodiments, there may be extendable stabilizing bars 194 on multiple sides of the platform 192. The multiple extendable stabilizing bars 194 may be controlled separately or as single entity. In some embodiments, there may be multiple stabilizing bars 194 on a side of the platform assembly 192.

### Controller

Lift vehicle 100 includes controller 305, according to some embodiments. Controller 305 is configured to receive sensor information from various sensors (e.g., position sensors, force sensors, etc.) of lift vehicle 100, user inputs from any user interfaces, feedback from any pumps, engines, actuators, etc., of each lift device, and operate any controllable elements (e.g., operate tractive elements, drive lift devices, operate lift actuators to raise or lower platforms, extend the stabilizing bars, etc.) based on any sensor inputs and user inputs. In some embodiments, controller 305 is configured to display any received sensory information, operational information, calculated properties, etc., of the lift device. Controller 305 can operate any controllable elements of the lift device by generating and providing control signals to the controllable elements. Controller 305 can be positioned anywhere on the lift device.

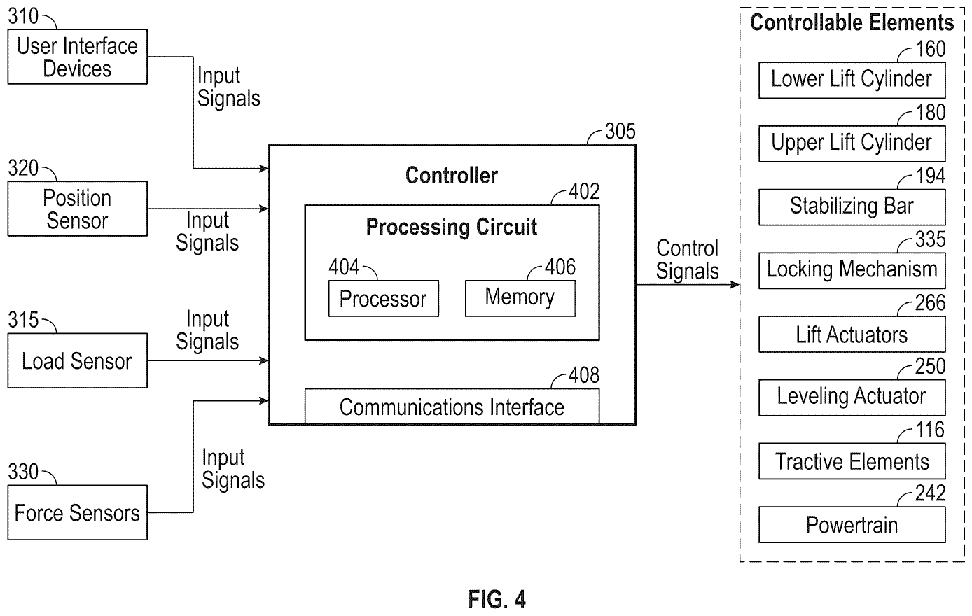

Referring now to FIG. 4, according to an exemplary embodiment, the lift vehicle 100 includes one or more load sensors 315 to measure a force applied on the platform by the stabilizer bar. The load sensors 315 may be any one or many of a load cell, a weight sensor, strain gauge, etc. In some embodiments, the stabilizing bar 194 includes a plurality of force sensors 330 (e.g., load cells, hydraulic cylinders, etc.) communicably coupled to the controller 305 and used to detect the amount of force being applied to the stabilizing bar bumper. The force exerted by the stabilizing bar 194 onto the external support and against the platform assembly 192, is limited to a maximum force. In some embodiments, the maximum force can be the force at which the lift vehicle 100 can no longer maintain the position of the platform assembly 192. For example, the maximum force can be 50 lbs. Still in other embodiments, the maximum force can be 90 lbs, or any predetermined force selected by an operator or a manufacturer of the vehicle. If, during use, the force exerted onto the stabilizing bar 194 exceeds the maximum force, the distance between the stabilizing bar front 196 and the platform assembly 192 is adjusted (e.g., shortened) by the stabilizing bar actuator 200 to adjust the position of the platform assembly 192 and lower the force the stabilizing bar 194 exerts on the platform assembly 192. In some instances, if, during use, the force exerted on the stabilizing bar 194 exceeds the maximum force, the controller 305 may additionally or alternatively cause the lift vehicle 100 to move away from the external support by activating the powertrain 242 to move the lift vehicle 100 via the tractive elements 116.

Upon receiving an indication that the amount of force applied to the bumper is sufficient, the controller may notify an operator to turn off a portion of the machine or disengage a function of the stabilizing bar 194. In some embodiments, the controller is also configured to notify the operator of an excessive amount of force being applied to the bumper. In some embodiments, this notification may instruct the operator to manually decrease the amount of force being driven to the stabilizing bar 194. In some embodiments, the stabilizing bar 194 includes a plurality of position sensors 320 (e.g., ultrasonic sensors, proximity sensors, etc.) communicably coupled to the controller 305 and used to detect the position of the stabilizing bar 194 relative to the platform assembly 192 and the external support. Upon receiving an indication that the stabilizing bar 194 has reached a positional threshold, the controller 305 may modify the amount of force provided to the stabilizing bar 194.

According to an exemplary embodiment, the position of the stabilizing bar 194 relative to the platform assembly 192 can be locked by one or more mechanisms, shown as locking mechanism 335. The locking mechanism 335 can be mechanical such that the force exerted on the stabilizing bar 194 from the external support and passed to the platform assembly 192 is substantially borne (e.g., +/−10%) by the locking mechanism 335 and not by the stabilizing bar actuators 200. The position lock of stabilizing bar 194 can thereafter increase the stability by locking the position to remove compliance associated with the stabilizing bar actuators 200.

For example, in some instances, the stabilizing bar actuators 200 may, under pressure, undergo a minor amount of unintended movement (e.g., compliance) due to compression and/or expansion of a fluid inside the actuator. The locking mechanism 335 can remove the stabilizing bar actuators 200 from the path of the force between the external support and the platform assembly 192, thereby stiffening the position of the stabilizing bar 194 and improving the stability of platform assembly 192. In some embodiments, the stabilizing bar 194 can be locked in either of the first position and the second position via the locking mechanism 335. In some embodiments, the locking mechanism 335 can lock the stabilizing bar 194 in any number of positions between and including the first position and the second position. In some embodiments, the locking mechanism 335 can include any type of mechanical locking system, for example an automated pin lock.

In some embodiments, the stabilizing bar 194 is force-limited, such that it only exerts a maximum amount of force on lift vehicle 100. For example, the force limit can be 50 lbs., such that the stabilizing bar can selectively extend and/or retract to ensure the force on the lift vehicle 100 is at or below 50 lbs.

Controller 305 can include a communications interface 408. Communications interface 408 may facilitate communications between controller 305 and external systems, device, sensors, etc. for control, monitoring, adjustment to any of the communicably connected devices, displays, systems, prime movers, etc.

Communications interface 408 can be or include wired or wireless communications interfaces (e.g., jacks, antennas, transmitter, receivers, transceivers, wire terminals, etc.) for conducting data communications with sensors, devices, systems, etc., of lift vehicle 100, or other external systems or devices (e.g., an administrative device). In various embodiments, communications via communications interface 408 can be direct (e.g., local wired or wireless communications) or via a communications network (e.g., a WAN, the Internet, a cellular network, etc.). For example, communications interface 408 can include an Ethernet card and port for sending and receiving data via an Ethernet-based communications link or network. In another example, the communications interface 408 can include a Wi-Fi transceiver for communicating via a wireless communications network. In some embodiments, communications interface 408 is or includes a power line communications interface. In other embodiments, communications interface 408 is or includes an Ethernet interface, a USB interface, a serial communications interface, a parallel communications interface, etc.

Controller 305 includes a processing circuit 402, a processor 404, and memory 406. Processing circuit 402 can be communicably connected to communications interface 408 such that processing circuit 402 and the various components thereof can send and receive data via communications interface 408. Processor 404 can be implemented as a general purpose processor, an application specific integrated circuit (ASIC), one or more field programmable gate arrays (FPGAs), a group of processing components, or other suitable electronic processing components.

Memory 406 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 406 can be or include volatile memory or non-volatile memory. Memory 406 can include database components, object code components, script components, or any other type of information structure for supporting the various activities and information structures described in the present application. According to some embodiments, memory 406 is communicably connected to processor 404 via processing circuit 402 and includes computer code for executing (e.g., by processing circuit 402 and/or processor 404) one or more processes described herein.

During manual operation, the controller 305 receives inputs from the plurality of user interface devices 310 and uses these received signals to conduct various operations of the lift vehicle 100, including the stabilizing bar 194. In some embodiments, the user interface devices 310 may include a graphic user interface, any number of buttons, levers, knobs, switches, etc., or any other user input devices configured to receive an input from the operator of lift vehicle 100. For example, the received inputs from the user interface devices 310 may include any of a position for the stabilizing bar 194 to be driven to, a length of extension for the stabilizing bar 194 to be extended to, a force for the stabilizing bar actuator(s) 200 to be driven to, and/or a retraction length for the stabilizing bar 194 to be set to. In some instances, the received inputs may additionally include instructions to operate various other systems of the lift vehicle 100 (e.g., any of the various the controllable elements shown in FIG. 4).

Upon receiving the signals from the user interface devices 310, the controller 305 sends control signals to the controllable elements of the lift vehicle 100. For example, in some instances, the controller 305 sends control signals to the stabilizing bar actuator 200 to operate the stabilizing bar 194 in accordance with input specifications. In some embodiments, the extension of the stabilizing bar 194 is an automatic process, wherein the controller 305 operates the stabilizing bar actuator 200 to extend or retract the stabilizing bar 194 based on a plurality of sensed values regarding the state of the lift vehicle 100, the platform assembly 192, the stabilizing bar 194, and any other relevant parameters or the lift vehicle 100.

In some embodiments, the controller 305 is configured to limit manual control of the stabilizer bar 194. For example, the controller 305 may enforce a limit on the maximum allowable extension of the stabilizer bar 194, the maximum force applied by the stabilizer bar 194, the minimum allowable extension of the stabilizer bar 194, or when the stabilizer bar 194 can operate. For further example, when an operator is moving the platform 192, the controller 305 may restrict the operator from simultaneously attempting to move the stabilizing bar 194. The limit (e.g., extended distance, force applied, time of operation) may be predefined and can depend on the type of lift vehicle 100, the position of the platform 192 in the moving envelope of the lift vehicle 100, the weight or load of the platform 192, and environmental factors such as temperature, wind, humidity, rain, etc. For example, the lift vehicle 100 may further include one or more atmospheric sensors coupled to the controller 305 to monitor the environment around the lift vehicle. In some embodiments, the atmospheric sensors may be positioned at or adjacent the platform 192 to monitor the atmospheric conditions proximate the platform 192, which may be different from the atmospheric conditions on the ground.

In some embodiments, the controller 305 can be configured to automatically control the position of the stabilizing member 194. The automatic control process may include receiving signals from a plurality of sensors regarding one or more parameters such as a position of the extendable stabilizing member 194, force applied to the extendable stabilizing member 194, height of the platform assembly 192, stability of the lift vehicle 100, operating envelope of the lift vehicle 100. Upon receiving signals from the sensors of the lift vehicle 100, the controller 305 may determine a threshold regarding position and/or force for the stabilizing bar 194. The controller 305 will then operate the controllable elements according to the calculated or predetermined thresholds.

In some embodiments, the stabilizing bar bumper 198 includes at least one proximity sensor 320. The proximity sensor(s) 320 send position data regarding the distance between the bumper 198 and the external support surface to the controller 305. This indication allows the controller 305 to verify that the stabilizing bar 194 has reached the position threshold and will also verify that the position threshold is being maintained.

In some embodiments, the controller may be configured to provide one or more alerts or indications to an operator (e.g., via communications interface 408, user inputs device 310, etc.) indicating a status of the stabilizing bar. The indications can be audible, visual, or aural. A characteristics of the indication such as an intensity, frequency, color, tone, etc., can be adjusted to alert an operator to one or more changes in the condition of the stabilizing bar 194. The indications may be based on a change to provide one or more indicating the distance of the stabilizing bar 194 from a support surface. The indications may be based on one or more conditions such as a position, a force value, a proximity from a surface, etc. of the stabilizer bar 194.

For example, during manual control, the controller 305 may be configured to provide an indication based on the distance between the stabilizing bar 194 and the support surface. The controller 305 can send a repeating tone that increases in frequency (i.e., beeps faster) as the stabilizing bar 194 approaches the support surface. The controller 305 may further be configured to generate a second indication when the stabilizing bar 194 contacts the support surface. The second indication may be different than the first indication. In some embodiments, the controller may be configured to provide an indication based on the signal from the one or more force sensors such as load sensor 315. The controller 305 may be configured to provide the indication upon reaching the predetermined force threshold, and/or at one or more intermediate force thresholds, to provide an operator extending the stabilizing bar 194 manually with feedback useful for determining when the stabilizing bar 194 is in a desired position or is exerting a desired amount of force.

In some embodiments, during autonomous control and/or remote control of the stabilizing bar 194 the controller 305 may be configured to provide an indication when the stabilizing bar has satisfied one or more conditions such as a position, a force value, a proximity from a surface, etc. For example, the controller 305 may be configured to provide an alert when the force exerted by the stabilizing bar 194 on the platform 192 drops below a limit or at a rate that is above a rate threshold. The limit can be a percentage of the predetermined force of the stabilizer bar 194 are an independent limit minimum or maximum force value. The one or more indications can also indicate when the force applied by the stabilizing bar 194 rises above a threshold or at a rate above a threshold rate.

In some embodiments, the controller 305 is configured such that it operates a single stabilizing bar 194 to stabilize the platform assembly 192. The single extendable stabilizing bar 194 is configured such that it extends outward from the platform at an angle to optimize position stabilization and moment reduction. The controller 305 drives the extendable stabilizing bar 194 to a position and force threshold sufficient to stabilize the platform 192 and lift vehicle 100.

In some embodiments, the controller 305 is configured such that it operates multiple extendable stabilizing bar 194 to stabilize the platform assembly 192. In some embodiments, multiple extendable stabilizing bar 194 may each be driven to the same positional and force thresholds. In some other embodiments, the multiple extendable stabilizing bar 194 may be driven to the same positional threshold but different force thresholds. In yet another embodiment, the multiple extendable stabilizing bar 194 may be each driven to different positional and force thresholds.

In some embodiments, the multiple extendable stabilizing bar 194 are configured such that they are coordinated in their operation wherein each of the extendable stabilizing bar 194 move concurrently and are drive to the same positional and force threshold. During this coordinated operation, the controller 305 receives (e.g., obtains, acquires, etc.) values from the plurality of sensors (i.e., position sensors 320, force sensors 330, etc.), and compares these sensed values to ensure concurrent operation and proper configuration.

In some embodiments, the multiple extendable stabilizing bar 194 are configured such that they are individually operated, wherein each of the extendable stabilizing bar 194 are operated sequentially. During this individual operation, the controller 305 operates a first stabilizing bar 194, driving it to both a positional threshold and a force threshold. The controller 305 may then ensure that the first extendable stabilizing bar 194 has reached the positional and force threshold. Once the first extendable stabilizing bar 194 is confirmed to be at the positional and/or force threshold, the controller 305 drives the next extendable stabilizing bar 194 to a positional threshold and/or force threshold, the thresholds may or may not be the same as those of the first extendable stabilizing bar 194. This process will continue until each of the multiple extendable stabilizing bar 194 reach their respective positional and force thresholds.

In some embodiments, the multiple extendable stabilizing bar 194 are controlled to move in different directions. During this different direction operation of the extendable stabilizing bars 194, at least one extendable stabilizing bar 194 is extended outward from the platform assembly 192 towards an external support surface, while at least one other extendable stabilizing bar 194 is retraced inwards toward the platform assembly 192. In some embodiments, the multiple extendable stabilizing bar 194 are operated concurrently such that the at least one extendable stabilizing bar 194 is extended outward at the same time that the at least one other stabilizing bar is retracted inward.

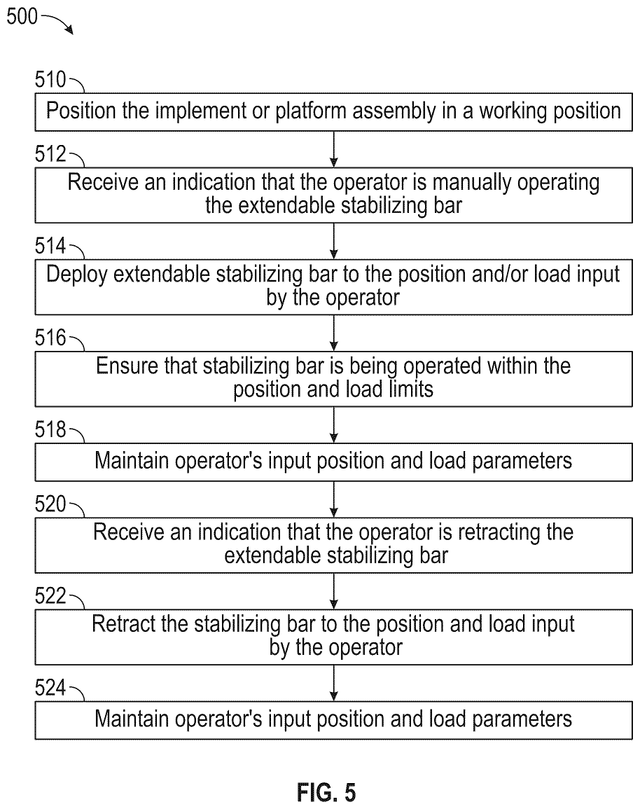

FIG. 5 is a flowchart of the manual operation of the extendable stabilizing bars 194. The process 500 depicts the manual operation of the extendable stabilizing bars, according to an example embodiment. At step 510, the controller 305 determines the platform assembly 192 to be in a working position. The working position includes a fully retracted position, a fully extended position, and any position in between the fully retracted and fully extended positions.

At step 512, the controller 305 receives an indication that the operator is manually operating the extendable stabilizing bar 194 to engage an external support surface to stabilize the lift vehicle 100. The received indication comes from the user interface devices 310 and may include any interaction with graphic user interface, any number of buttons, levers, knobs, switches, etc., or any other user input devices configured to receive an input from the operator of lift vehicle 100.

At step 514, the controller 305 operates the stabilizing bar actuator 200 according to the parameters input by the operator. In some embodiments, the input by the operator may include only a positional threshold for the stabilizing bar 194. In some other embodiment, the operator input may include only a force threshold for the stabilizing bar 194. In yet another embodiment, the operator input may include both a positional and force threshold for the stabilizing bar 194. The operation of the stabilizing bar 194 includes deploying the extendable stabilizing bar 194 to the positional and force threshold input by the operator.

At step 516, the controller 305 ensures that the stabilizing bar 194 is being operated according to the positional and force thresholds. That is, the controller 305 determines whether the force of the stabilizing bar 194 is below the force threshold, and that the position of the stabilizing bar 194 is the desired position based on the user inputs. During step 516, many relevant parameters are monitored by the controller 305. In some embodiments, the parameters monitored by the controller 305 may be any of the signals received from the load sensor 315, the force sensors 330, the position sensors 320, the user interface devices 310, the orientation sensor 206, the rotation sensor 317, or any other sensor communicably coupled with the controller 305.

At step 518, the controller 305 operates one or more of the controllable equipment to maintain the operator's input parameters. The controllable equipment includes the lower lift cylinder 160, the upper lift cylinder 180, the stabilizing bar 194, the locking mechanism 335, the lift actuators 266, the leveling actuators 250, the tractive elements 116, the powertrain 242 and any other element configured to receive control signals from the controller 305. In order to verify that the controllable equipment is maintaining the input parameters, the controller 305 maintains communication with the sensors with which it is communicably coupled.

At step 520, the controller 305 receives an indication that the operator is retracting the extendable stabilizing bar 194. The received indication comes from the user interface devices 310 and may include any interaction with graphic user interface, any number of buttons, levers, knobs, switches, etc., or any other user input devices configured to receive an input from the operator of lift vehicle 100.

At step 522, in response to receiving an indication that the operator is retracting the extendable stabilizing bar 194, the controller 305 operates the stabilizing bar actuator 200 to retract the extendable stabilizing bar 194 from a deployed position to a threshold input by the operator. The deployed position is a position in which the extendable stabilizing bar 194 is distal the chassis 118. In some embodiments, the input by the operator may include only a positional threshold for the stabilizing bar 194. In some other embodiment, the operator input may include only a force threshold for the stabilizing bar 194. In yet another embodiment, the operator input may include both a positional and force threshold for the stabilizing bar 194. The operation of the stabilizing bar 194 includes retracting the extendable stabilizing bar 194 to the positional and force threshold input by the operator.

At step 524, the controller 305 operates the controllable equipment to maintain the position and force thresholds input by the operator. In order to verify that the controllable equipment is maintaining the input parameters, the controller 305 maintains communication with the sensors with which it is communicably coupled.

It should be appreciated that the method 500 discussed above is provided as an example, and is not meant to be limiting. For example, as referenced above, in some instances, instead of or in addition to the operator manually operating the stabilizing bar 194, at step 512, the operator may control the lift vehicle 100 to move forward or backward (e.g., via a command to the tractive elements 116) to engage the stabilizing bar 194 with the support surface to stabilize the lift vehicle 100. In these instances, the controller 305 may similarly monitor the force being applied to the stabilizing bar 194 by the support surface and control the lift vehicle (e.g., the tractive elements 116) to move toward or away from the support surface to ensure that the applied force is at an appropriate level. In some of these instances, the stabilizing bar 194 may be stationary (e.g., fixed in the second position shown in FIG. 3B) instead of being selectively extendable via an actuator.

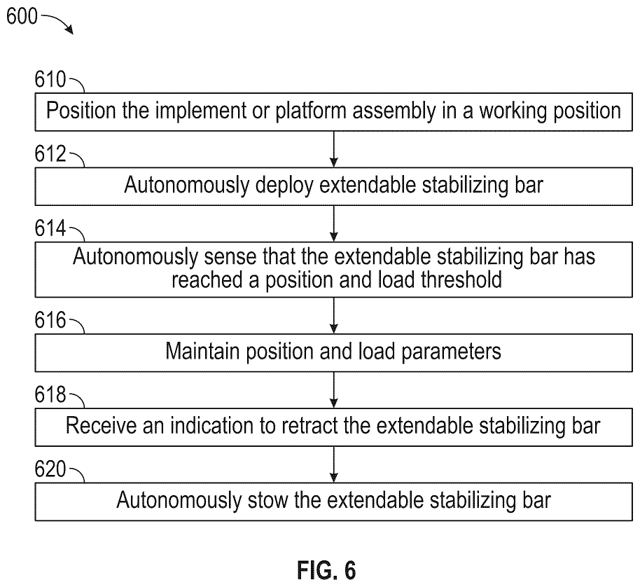

FIG. 6 is a flowchart of the automatic operation of the extendable stabilizing bar 194. The process 600 depicts the automatic operation of the extendible stabilizing bars 194, according to an example embodiment. At step 610, the controller 305 determines the platform assembly 192 to be in a working position. The working position includes a fully retracted position, a fully extended position, and any position in between the fully retracted and fully extended positions.

At step 612, the controller 305 autonomously deploys the extendable stabilizing bar 194 to engage an external support surface to stabilize the lift vehicle 100. The automatic deployment of the stabilizing bar 194 includes extending the stabilizing bar actuator 200, driving the extendable stabilizing bar 194 outward from the platform assembly 192.

At step 614 the controller 305 senses that the extendable stabilizing bar 194 has reached a predetermined positional and/or force threshold stored on the controller 305. During step 614, many relevant parameters are continuously monitored by the controller 305. In some embodiments, the parameters monitored by the controller 305 may be any of the signals received from the load sensor 315, the force sensors 330, the position sensors 320, the user interface devices 310, the orientation sensor 206, the rotation sensor 317, or any other sensor communicably coupled with the controller 305.

At step 616, in response to receiving an indication that the stabilizing bar 194 has reached a predetermined threshold for position and/or load, the controller 305 operates the controllable equipment such that compliance with the thresholds is maintained. The controllable equipment includes the lower lift cylinder 160, the upper lift cylinder 180, the stabilizing bar 194, the locking mechanism 335, the lift actuators 266, the leveling actuators 250, the tractive elements 116, the powertrain 242 and any other element configured to receive control signals from the controller 305. In order to verify that the controllable equipment is maintaining the input parameters, the controller 305 maintains communication with the sensors with which it is communicably coupled.

At step 618, the controller 305 receives an indication to retract the extendable stabilizing member. In some embodiment, this indication comes from one of the sensors communicably coupled to the controller 305. In some other embodiment, this indication can come from a change in the position of the platform assembly 192.

At step 620, in response to receiving an indication to retract the extendable stabilizing bar 194, the controller 305 will autonomously retract the extendable stabilizing bar 194 to a stowed position.

It should be appreciated that the method 600 discussed above is provided as an example, and is not meant to be limiting. For example, as referenced above, in some instances, instead of or in addition to autonomously operating the stabilizing bar 194, at step 612, the controller 305 may automatically control the lift vehicle 100 to move forward or backward (e.g., via a command to the tractive elements 116) to engage the stabilizing bar 194 with the support surface to stabilize the lift vehicle 100. In these instances, the controller 305 may similarly monitor the force being applied to the stabilizing bar 194 by the support surface and control the lift vehicle (e.g., the tractive elements 116) to move toward or away from the support surface to ensure that the applied force is at an appropriate level. In some of these instances, the stabilizing bar 194 may be stationary (e.g., fixed in the second position shown in FIG. 3B) instead of being selectively extendable via an actuator.

### Configuration of Exemplary Embodiments

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled”provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure. Additionally, references herein to the specification of a primary arm and a secondary arm are merely used to provide clarity to the figures. It should be noted that any acts, operations, movements, etc., performed by the primary arm can also be performed by the secondary arm (and/or additional arms), and vice versa.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the lift vehicle 100 and the systems and components thereof as shown in the various exemplary embodiments is illustrative only. Additionally, any element disclosed in one embodiment may be incorporated or utilized with any other embodiment disclosed herein.

What is claimed is:

1. A lift vehicle, comprising:
a chassis;
a platform configured to support an operator;
a lift apparatus configured to raise or lower the platform;
an extendable stabilizing member coupled to the platform, the extendable stabilizing member configured to selectively engage an external support surface to stabilize and support the platform;
an actuator configured to selectively move the extendable stabilizing member between a stowed position, in which the extendable stabilizing member is configured to disengage from the external support surface, and a deployed position, where the extendable stabilizing member is configured to engage the external support surface;
a load sensor configured to measure an amount of force applied to the extendable stabilizing member; and
a controller configured to:
obtain the force being applied to the extendable stabilizing member from the load sensor; and
control a position of the extendable stabilizing member via the actuator based on the force being applied to the extendable stabilizing member.

2. The lift vehicle of claim 1, further comprising a plurality of extendable stabilizing members configured to stabilize the platform in multiple directions.

3. The lift vehicle of claim 1, wherein the actuator of the extendable stabilizing member is a linear electric actuator.

4. The lift vehicle of claim 1, wherein a bumper of the extendable stabilizing member is made of a flexible material configured to prevent damage to the external support surface when the extendable stabilizing member engages the external support surface.

5. The lift vehicle of claim 1, further comprising a lock configured to selectively lock the position of the extendable stabilizing member upon the extendable stabilizing member reaching a desired position.

6. The lift vehicle of claim 1, wherein the controller is configured to provide one or more alerts to an operator indicative of a status of the extendable stabilizing member.

7. The lift vehicle of claim 1, wherein the controller is configured to determine a reach envelope based on the position of the extendable stabilizing member, wherein the reach envelope is increased in size responsive to a user input indicating that the extendable stabilizing member will be extended during a work operation.

8. The lift vehicle of claim 1, wherein the controller is further configured to maintain the force being applied to the extendable stabilizing member at or below a threshold force of the extendable stabilizing member.

9. The lift vehicle of claim 8, wherein the threshold force of the extendable stabilizing member is based on at least one of:
a height of the platform;
a load on the platform;
a position of the platform within a reach envelope determined by the controller;
a predetermined maximum force;
a predetermined force for manual operation;
a predetermined force for remote or autonomous operation;
wind or other environmental conditions;
a type of implement being used; and
a type of work being performed.

10. The lift vehicle of claim 1, wherein the extendable stabilizing member is removably coupled to the platform at one of a top of the platform or a bottom of the platform.

11. The lift vehicle of claim 1, further comprising a plurality of tractive elements configured propel the lift vehicle, and wherein the controller is further configured to control operation of the plurality of tractive elements based on at least one of the force being applied to the extendable stabilizing member.

12. The lift vehicle of claim 1, wherein the controller is further configured to selectively move the extendable stabilizing member between the stowed position and the deployed position based on a user input.

13. The lift vehicle of claim 1, wherein the controller is further configured to autonomously move the extendable stabilizing member between the stowed position and the deployed position based on signals received from at least one of a position sensor or a load sensor.

14. A platform for a lift device includes:
an extendable stabilizing member configured to engage an external support surface to stabilize and support the platform;
an actuator configured to extend or retract the extendable stabilizing member in a direction outwards from a chassis of the lift device;
a load sensor configured to measure an amount of force applied to the extendable stabilizing member;
a lock configured to selectively lock a position of the extendable stabilizing member; and
a controller configured to:
obtain the force being applied to the extendable stabilizing member from the load sensor;
control the position of the extendable stabilizing member such that the force is less than or equal to a threshold force; and
selectively engage the lock to lock the position of the extendable stabilizing member.

15. The platform of claim 14, wherein selectively engaging the lock further comprises operating the lock to remove the actuator from a path of force between the external support surface and the platform.

16. The platform of claim 14, wherein the controller is configured to provide one or more indications regarding a current status of the extendable stabilizing member, the one or more indications comprising at least one of an audible indication or a visual indication.

17. The platform of claim 14, wherein the extendable stabilizing member is selectively coupled to the platform at one of a top of the platform, a bottom of the platform, or a position in between the top of the platform and the bottom of the platform.

18. A lift vehicle, comprising:
a chassis;
a lift apparatus configured to raise or lower an implement or a platform;
a stabilizing member configured to engage an external support to stabilize and support the implement or the platform;
a load sensor configured to measure an amount of force applied to the stabilizing member; and
a controller configured to:
obtain the force being applied to the stabilizing member from the load sensor;
control a position of the lift vehicle such that the force is less than or equal to a threshold force.

19. The lift vehicle of claim 18, wherein the threshold force is provided as a user input from a user interface.

20. The lift vehicle of claim 18, wherein the controller is further configured to generate an alert signal based on the force being applied to the stabilizing member.
